(19) United States
(12) Patent Application Publication
(10) Pub. No.: US 2021/0062038 A1
(43) Pub. Date: Mar. 4, 2021

(54) METAL SURFACE TREATMENT COMPOSITION HAVING EXCELLENT SLIP RESISTANCE, AND METAL MATERIAL TO WHICH SAME IS APPLIED

(71) Applicant: POSCO, Pohang-si, Gyeongsangbuk-do (KR)

(72) Inventors: Jin-Tae KIM, Gwangyang-si, Jeollanam-do (KR); Myung-Soo KIM, Gwangyang-si, Jeollanam-do (KR); Jung-Hwan LEE, Gwangyang-si, Jeollanam-do (KR); Ha-Na CHOI, Gwangyang-si, Jeollanam-do (KR)

(21) Appl. No.: 16/957,951

(22) PCT Filed: Dec. 11, 2018
(86) PCT No.: PCT/KR2018/015714

§ 371 Date: Jun. 25, 2020

(30) Foreign Application Priority Data
Dec. 26, 2017 (KR) 10-2017-0179042

(51) Int. Cl. C09D 183/08; C09D 7/63; C09D 5/08

(52) U.S. Cl. CPC C09D 183/08; C09D 5/086; C09D 7/63

(57) ABSTRACT

The present invention relates to a chromium-free metal surface treatment composition comprising 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent. The metal surface treatment composition of the present invention can ensure slip resistance and required properties such as corrosion resistance and workability, thereby enabling a metal material to be prevented from slipping or falling off during processing, pipe making and the like.

### TECHNICAL FIELD

The present invention relates to a metal surface treatment composition having excellent slip resistance, and a metal material to which the same is applied.

### BACKGROUND ART

Generally, to alleviate slippage of a surface of a tile, marble, and the like, used as a finishing material for a wall or a floor of a bathroom, a pool, and the like, a composition containing an ammonia fluoride component and a reaction modifier such as ammonium hydroxide are added to prevent slippage or slip properties.

Japanese Laid-Open Patent Publication No. 1994-279748, U.S. Pat. No. 5,223,168, Japanese Laid-Open Patent Publication No. 1988-159278, and the like, disclose an anti-slip agent in the form of aqueous solution including a hydrogen fluoride aqueous solution as a main component or including fluoride salts such as ammonia fluoride as a main component and additionally including a surfactant to alleviate slipping of a surface of an inorganic floor material as above.

However, when a chemical material as above is applied to secure slip resistance of a steel material such as a stainless steel sheet, solution stability may degrade, and corrosion resistance may be weakened, which may be a problem.

Further, in the case in which inorganic coating or corrosion resistance coating is applied to a steel material, when a processing oil such as water or crude oil is introduced to a surface of a material, a water film phenomenon occurs on a surface of the material such that slippage may increase. Accordingly, due to damage and slipping of the material, a process delay may occur, or a serious safety accident may occur.

However, there has been no anti-slip agent applied to a steel material such as a stainless steel sheet for slip resistance, prevention of slipping, and accordingly, the demand for a technique which may improve slip resistance of a surface of a steel material has been increased.

### PRIOR ART

### Reference

Japanese Laid-Open Patent Publication No. 1994-279748

U.S. Laid-Open Patent Publication No. 5,223,168

Japanese Laid-Open Patent Publication No. 1988-159278

### DISCLOSURE

### Technical Problem

The present invention is to address the issue described above and, and the purpose of the present invention is to provide a metal surface treatment composition which may secure properties such as corrosion resistance, workability, and the like, of a metal material such as steel, and the like, and also stable slip resistance, and a metal material to which the same is applied.

### Technical Solution

According to an aspect of the present invention, provided is a chromium-free metal surface treatment composition including 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent.

A wax may be a polypropylene wax.

A weight average molecular weight of a wax may be 2,000-10,000.

A melting point of a wax may be 130-160° C.

An organic acid may be one or more selected from among formic acid, phosphoric acid, and acetic acid.

A silane-based compound may be one or more selected from a group consisting of epoxy-based silane and amino-based silane.

Epoxy-based silane may be one or more selected from among vinylmethoxy silane, vinyltrimethoxy silane, vinylepoxy silane, vinyltriepoxy silane, 3-aminopropyltriepoxy silane, 3-glycidoxy propyltrimethoxy silane, 3-methacryloxypropyltrimethoxy silane, 3-mercaptopropyl trimethoxy silane, N-(1,3-dimethylbutylidene)-3-(triepoxy silane)-1-propanamine, and N,N-bis[3-(trimethoxysilyl) propyl] ethylenediamine.

Amino-based silane may be one or more selected from among N-(β-aminoethyl)-γ-amino propylmethyldimethoxysilane, N-(β-aminoethyl)-γ-aminopropyltrimethoxysilane, γ-glycidoxypropyltriethoxysilane, γ-glycine cydoxitrimethyldimethoxysilane, 2-(3,4-epoxycyclohexyl)ethyltrimethoxysilane, γ-methacryloxypropyltrimethoxysilane, γ-methacryloxypropyltriethoxysilane, γ-mercaptopropyltrimethoxysilane, γ-mercapto propyltriethoxysilane, 3-amino propyl triethoxy silane, and N-[2-(vinylbenzylamino)ethyl]-3-aminopropyltrimethoxysilane.

The chromium-free metal surface treatment composition may further include 0.01-1 parts by weight of a defoamer and 1-2 parts by weight of a wetting agent.

A defoamer may be n-methylethanol amine.

The wetting agent may be one or more selected from among isopropyl alcohol, 2-ethyl-1-hexanol, 2-butoxyethanol, dipropylene glycol, ethylene glycol, n-propyl alcohol, and propylene glycol.

According to another aspect of the present invention, a surface treatment metal material having excellent slip resistance including a metal material; and a coating layer formed on the metal material, and formed as a cured product of a metal surface treatment composition including 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent may be provided.

A thickness of the coating layer may be 0.5-10 μm.

A coefficient of friction of the coating layer may be 0.4-0.6.

A wax may be a polypropylene wax.

A weight average molecular weight of a wax may be 2,000-10,000.

A melting point of a wax may be 130-160° C.

The metal surface treatment composition further may include 0.01-1 parts by weight of a defoamer and 1-2 parts by weight of a wetting agent.

The metal material may be one selected from among a stainless steel sheet, a galvanized steel sheet, an aluminum plated steel sheet, and an alloy plated steel sheet.

### Advantageous Effects

The metal surface treatment composition of the present invention may secure required properties such as corrosion resistance, workability, and the like, and also slip resistance such that a phenomenon in which a metal material slips in processing, pipe making, and the like, may be prevented.

### DESCRIPTION OF DRAWINGS

FIG. 1 is a result of measurement of a coefficient of friction of embodiment 1; and

FIG. 2 is a result of measurement of a coefficient of friction of comparative example 1.

### BEST MODE FOR INVENTION

A preferable embodiment of the present invention will be described with reference to various embodiments. However, the embodiment of the present invention may be modified to different forms of embodiments, and the scope of the present invention is not limited to the embodiment described below.

The present invention relates to a metal surface treatment composition having excellent slip resistance, and a metal material to which the same is applied.

The metal surface treatment composition may include 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent.

The silane-based compound may be hydrolyzed in water and may generate siloxide bonds, may be strongly bonded with a metal material and may work as a binder for bonding various inorganic materials, and may be added to improve adhesion, corrosion resistance, and the like, of a coating layer. A silane-based compound is not limited thereto, however. For example, preferably, a silane-based compound may be one or more selected from a group consisting of epoxy-based silane and amino-based silane.

As epoxy-based silane, vinylmethoxy silane, vinyltrimethoxy silane, vinylepoxy silane, vinyltriepoxy silane, 3-aminopropyltriepoxy silane, 3-glycidoxy propyltrimethoxy silane, 3-methacryloxypropyltrimethoxy silane, 3-mercaptopropyl trimethoxy silane, N-(1,3dimethylbutylidene)-3-(triepoxy silane)-1-propanamine, N,N-bis[3-(trimethoxysilyl) propyl] ethylenediamine, or the like, may be used, and preferably, 3-glycidoxy propyltrimethoxy silane may be used.

Also, as amino-based silane, N-(β-aminoethyl)-γ-amino propylmethyldimethoxysilane, N-(β-aminoethyl)-γ-aminopropyltrimethoxysilane, γ-glycidoxypropyltriethoxysilane, γ-glycine cydoxitrimethyldimethoxysilane, 2-(3,4-epoxycyclohexyl)ethyltrimethoxysilane, γ-methacryloxypropyltrimethoxysilane, γ-methacryloxypropyltriethoxysilane, γ-mercaptopropyltrimethoxysilane, γ-mercapto propyltriethoxysilane, 3-amino propyl triethoxy silane, N-[2-(vinylbenzylamino)ethyl]-3-aminopropyltrimethoxysilane, or the like, may be used, and preferably, 3-amino propyl triethoxy silane may be used.

A preferable content of the silane-based compound may be 10-30 parts by weight, and may be 10-20 parts by weight more preferably. When a content of the silane-based compound is less than 10 parts by weight, corrosion resistance and adhesion may be deteriorated. When the content exceeds 30 parts by weight, solution stability may degrade, which may not be preferable.

An organic acid included in the metal surface treatment composition of the present invention may be necessary to improve adhesion between the metal material and a coating layer. A type of an organic acid is not limited to any particular type. However, for example, preferably, an organic acid may be one or more selected from a group consisting of formic acid, phosphoric acid and acetic acid.

A preferable content of an organic acid may be 0.5-6 parts by weight. When a content of an organic acid is less than 0.5 parts by weight, etching properties may be deteriorated. When the content exceeds 6 parts by weight, stability of a solution and property of a painted film may be deteriorated.

The vanadium compound and the magnesium compound may form a stable metal chelate compound by inducing chelate reaction, and accordingly, cohesion force between metal atoms of the metal material and the coating layer may increase such that corrosion resistance and adhesion of a painted film may improve.

As the vanadium compound, vanadylacetylacetonate, vanadium pentoxide, metavanadine acid, ammonium metavanadate, sodium metavanadate, vanadium oxychloride, vanadium trioxide, vanadium dioxide, vanadium oxysulfate, vanadiumoxyacetylacetate, vanadium acetyl acetate, vanadium trichloride, or the like, may be used, and preferably, the vanadium compound may be vanadylacetylacetonate. A preferable content of the vanadium compound may be 0.1-3 parts by weight. When a content of the vanadium compound is less than 0.1 parts by weight, the formation of metal chelate may be difficult. When the content exceeds 3 parts by weight, an unreacted metal compound may remain such that property of a solution may be deteriorated.

As the magnesium compound, magnesium oxide, magnesium sulfate, magnesium chloride, magnesium hydroxide, or the like, may be used, and preferably, magnesium oxide may be used. A preferable content of the magnesium compound may be 0.1-3 parts by weight. When a content of the magnesium compound is less than 0.1 parts by weight, the formation of metal chelate may be difficult. When the content exceeds 3 parts by weight, an unreacted metal compound may remain such that property of a solution may be deteriorated.

The metal surface treatment composition may include a wax. Generally, as a metal surface treatment composition for a steel sheet, or the like, a wax having a low melting point may be introduced to improve workability, and a wax may be used to provide lubricity by improving surface slip of a painted film at room temperature. However, differently from the above, as a wax is added to improve slip resistance in the present invention, a wax which does not have lubricity at room temperature, and which has a high melting point to increase friction properties. Accordingly, slip properties may decrease, and a coefficient of friction may increase.

A wax used for the metal surface treatment composition may be a polypropylene wax preferably. As a polypropylene wax, a polypropylene wax generally used in the field may be used. For example, one or more selected from between AQUACER 593 and AQUACER 597 of BYK Chemie may be used. A wax may be included by 0.5-5 parts by weight preferably, and may be included by 0.5-3 parts by weight more preferably. When a content thereof is less than 0.5 parts by weight, a coefficient of friction may be high such that it may be difficult to slip resistance. When the content exceeds 5 parts by weight, slip resistance may be favorable, but a painted film may be unstable such that corrosion resistance may be defective.

As described above, in the present invention, a wax should not have lubricity and should increase a coefficient of friction, the wax should have a high melting point preferably, and more preferably, a melting point of a wax may be 130-160° C.

Preferably, a weight average molecular weight of a wax may be 2,000-10,000. When a weight average molecular weight of a wax is less than 2,000, a wax may melt at low temperature such that slip properties may improve. When the weight average molecular weight exceeds 10,000, the wax may work as polypropylene plastic particles, instead of working as a wax, such that incompatibility with a solution may degrade and the wax may be precipitated, or the wax may be detached from a boundary surface with a solution after the solution is dried.

Meanwhile, the metal surface treatment composition may further include 0.01-1 parts by weight of a defoamer and 1-2 parts by weight of a wetting agent.

Bubbles generated in a coating composition may be generated in various stages of a process, and may cause a surface defect such as a crater phenomenon of a coating layer, weakened strength, and the like. Thus, it may be preferable to use a defoamer. As a defoamer, n-methylethanol amine may be used. A preferable content of a defoamer may be 0.01-1 parts by weight. When a content of a defoamer is less than 0.01 parts by weight, a defoaming effect may be insignificant. When the content exceeds 1 part by weight, a defoamer may become a cause for degradation of corrosion resistance and degradation of coating force of a coating layer.

Also, as a wetting agent added to improve wetting properties, isopropyl alcohol, 2-ethyl-1-hexanol, 2-butoxyethanol, dipropylene glycol, ethylene glycol, n-propyl alcohol, propylene glycol, a polyether siloxane copolymer based wetting agent may be used, and preferably, isopropyl alcohol may be used. A preferable content of a wetting agent may be 1-2 parts by weight. When a content of a wetting agent is less than 1 part by weight, an effect of improving wetting properties may be deteriorated, and adhesive force of a coating layer may degrade. When the content exceeds 2 parts by weight, property may not degrade but there may be no effect of improving wetting properties, which may not be economically preferable.

A solvent used in the present invention is not limited to any particular solvent, and water, ethanol, or the like, may be used. Preferably, a mixture of water and ethanol may be used, and more preferably, a mixture of 40-60 parts by weight of water and 10-20 parts by weight of ethanol may be used.

According to an embodiment of the present invention, a surface treatment metal material having excellent slip resistance including a metal material; and a coating layer formed on the metal material, and formed as a cured product of a metal surface treatment composition including 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent.

The coating layer may be a cured product of the metal surface treatment composition of the present invention, and may include a silane-based compound, an organic acid, a vanadium compound, a magnesium compound, a wax, a defoamer, and a wetting agent. A method of forming the coating layer may not be limited thereto. For example, one of methods such as roll-coating, spray-coating, slot-coating, impregnation coating, curtain coating, or the like, may be selected.

A preferable thickness of the coating layer may be 0.5-10 μm. When a thickness of the coating layer is less than 0.5 μm, corrosion resistance may be weakened. When the thickness exceeds 10 μm, workability may be weakened and manufacturing costs may increase, which may be problems.

As described above, the metal surface treatment composition of the present invention may include 0.5-5 parts by weight of a polypropylene wax which does not have lubricity at room temperature and has a high melting point to improve friction properties. Accordingly, as for the surface treatment metal material according to the present invention, the coating layer may have 0.4 or higher of a coefficient of friction, and more preferably, a coefficient of friction of the coating layer may be 0.4-0.6.

The surface treatment composition of the present invention may be used for various metal materials, and may be used for, for example, a stainless steel sheet, a galvanized steel sheet, an aluminum plated steel sheet, an alloy plated steel sheet, or the like, although not limited thereto. Also, required properties such as corrosion resistance, workability, and the like, and also slip resistance may be secured. Accordingly, slipping or falling off of a metal material may be prevented in processing, pipe making, and the like.

### MODE FOR INVENTION

### Embodiment

In the description below, the present invention will be described in greater detail through an embodiment. The embodiment described below is to describe the present invention in specific, and the present invention is not limited thereto.

A silane-based compound, an organic acid, a vanadium compound, a magnesium compound, and a wax were added to a solvent, and were stirred, thereby manufacturing a coating composition. As a solvent, a mixture of water and ethanol was used. As the silane-based compound, 3-glycidoxy propyl trimethoxy silane and 3-amino propyl triethoxy silane were used. Also, as an organic acid, formic acid and phosphoric acid were used, as the vanadium compound, vanadyl acetinacetonate was used, as the magnesium compound, magnesium oxide was used, and as a wax, a polypropylene wax, AQUACER 593 and AQUACER 597 of BYK Chemie were used.

Metal surface treatment compositions of embodiments 1 to 12 and comparative examples 1 to 8 were manufactured by adjusting the elements included in the compositions and contents thereof as in Tables 1 and 2. Thereafter, a galvanized steel sheet having a horizontal length of 75 mm and a vertical length of 150mm was coated with the coating compositions of embodiments 1 to 12 and comparative examples 1 to 8 by a thickness of 0.5 μm.

TABLE 1

| | (Unit: Parts by weight) | | | | | |
|---|---|---|---|---|---|---|
| | Embodiment 1 | Embodiment 2 | Embodiment 3 | Embodiment 4 | Embodiment 5 | Embodiment 6 |
| Epoxy-based Silane | 15 | 15 | 15 | 15 | 15 | 15 |
| Amino-based Silane | 15 | 15 | 15 | 15 | 15 | 15 |
| Vanadium Compound | 0.5 | 0.5 | 0.5 | 0.5 | 0.5 | 0.5 |
| Magnesium Compound | 2 | 2 | 2 | 2 | 2 | 2 |
| Phosphoric Acid | 3 | 3 | 3 | 3 | 3 | 3 |
| Formic Acid | 3 | 3 | 3 | 3 | 3 | 3 |
| Polypropylene-based | 0.2 | 0.5 | 1.5 | 3 | 5 | 7 |
| Aqueous Wax | | | | | | |
| (Melting Point: 160° C., | | | | | | |
| Molecular Weight 10000) | | | | | | |

TABLE 2

| | (Unit: Parts by weight) | | | | | |
|---|---|---|---|---|---|---|
| | Embodiment 7 | Embodiment 8 | Embodiment 9 | Embodiment 10 | Embodiment 11 | Embodiment 12 |
| Epoxy-based Silane | 15 | 15 | 15 | 15 | 15 | 15 |
| Amino-based Silane | 15 | 15 | 15 | 15 | 15 | 15 |
| Vanadium Compound | 0.5 | 0.5 | 0.5 | 0.5 | 0.5 | 0.5 |
| Magnesium Compound | 2 | 2 | 2 | 2 | 2 | 2 |
| Phosphoric Acid | 3 | 3 | 3 | 3 | 3 | 3 |
| Formic Acid | 3 | 3 | 3 | 3 | 3 | 3 |
| Polypropylene-based | 0.2 | 0.5 | 1.5 | 3 | 5 | 7 |
| Aqueous Wax | | | | | | |
| (Melting Point: 130° C., | | | | | | |
| Molecular Weight 2000) | | | | | | |

TABLE 3

| | (Unit: Parts by weight) | | | | | | | |
|---|---|---|---|---|---|---|---|---|
| | Comparative | | | | | | | |
| | Example 1 | Comparative | Comparative | Comparative | Comparative | Comparative | Comparative | Comparative |
| | (Cr Solution) | Example 2 | Example 3 | Example 4 | Example 5 | Example 6 | Example 7 | Example 8 |
| Epoxy-based Silane | — | 15 | 15 | 15 | 15 | 15 | 15 | 15 |
| Amino-based Silane | — | 15 | 15 | 15 | 15 | 15 | 15 | 15 |
| Vanadium Compound | — | 0.5 | 0.5 | 0.5 | 0.5 | 0.5 | 0.5 | 0.5 |
| Magnesium Compound | — | 2 | 2 | 2 | 2 | 2 | 2 | 2 |
| Phosphoric Acid | — | 3 | 3 | 3 | 3 | 3 | 3 | 3 |
| Formic Acid | — | 3 | 3 | 3 | 3 | 3 | 3 | 3 |
| Polyethylene Wax | — | — | 0.2 | 0.5 | 1.5 | 3 | 5 | 7 |
| (Melting Point 60-100° C., | | | | | | | | |
| Molecular Weight 600-1500) | | | | | | | | |

### EXPERIMENTAL EXAMPLE

Solution stability of the metal surface treatment compositions of embodiments 1 to 12 and comparative examples 1 to 8 were examined. Also, corrosion resistance of a stainless steel sheet on which a cured product (a coating layer) of the metal surface treatment composition was formed was tested, and an Erichsen test was conducted, and thereafter, corrosion resistance was examined, and a coefficient of friction was measured. Results of the tests were listed in Tables 3 and 4. Specific experimental conditions and examination methods are as below.

1. Solution Stability

The metal surface treatment compositions of embodiments 1 to 12 and comparative examples 1 to 8 were stored in a thermostat of 40° C. for one month, and thereafter, an increase of viscosity, gelling, and precipitation of the compositions were observed and examined under standards as below.

Good: No changes in an increase of viscosity, gelling, and precipitation of the solution

Defective: Changes in an increase of viscosity, gelling, and precipitation of the solution

2. Corrosion Resistance

5% of brine was continuously sprayed onto steel sheets which were coated with the coating compositions of embodiments 1 to 12 and comparative examples 1 to 8 by a thickness of 0.5 μm at humidity of 95% and 35° C. for 72 hours, and corrosion resistance was examined by observing an initial anti-rust area.

3. Corrosion Resistance After Erichsen Test

An Erichsen test was carried out on the steel sheets with 6mm, 5% of brine was continuously sprayed onto the steel sheets at humidity of 95% and 35° C., for 48 hours, and corrosion resistance was examined by observing an initial anti-rust area.

4. Coefficient of Friction

As for a coefficient of friction, the steel sheet was cut out in a size of A4, an area of friction TIP was controlled to be 2.9 cm×3.9 cm, 600 kgf weight was applied, the steel sheet was drawn at a drawing rate of 1000 mm/min, and a coefficient of friction was measured with a moving distance of 200 mm.

TABLE 4

| | Embodiment 1 | Embodiment 2 | Embodiment 3 | Embodiment 4 | Embodiment 5 | Embodiment 6 |
|---|---|---|---|---|---|---|
| Solution | Good | Good | Good | Good | Precipitation | Precipitation |
| Stability | | | | | in Small Amount | in Small Amount |
| Corrosion | White Rust | White Rust | White Rust | White Rust | White Rust | White Rust |
| Resistance | 0% | 0% | 0% | 0% | 10% | 30% |
| (72 hr) | | | | | | |
| Corrosion | White Rust | White Rust | White Rust | White Rust | White Rust | White Rust |
| Resistance | 0% | 0% | 0% | 0% | 30% | 50% |
| After Erichsen | | | | | | |
| Test (48 hr) | | | | | | |
| Coefficient | 0.25 | 0.53 | 0.5 | 0.47 | 0.51 | 0.5 |
| of Friction | | | | | | |

TABLE 5

| | Embodiment 7 | Embodiment 8 | Embodiment 9 | Embodiment 10 | Embodiment 11 | Embodiment 12 |
|---|---|---|---|---|---|---|
| Solution | Good | Good | Good | Good | Good | Percipitation |
| Stability | | | | | | in Small Amount |
| Corrosion | White Rust | White Rust | White Rust | White Rust | White Rust | White Rust |
| Resistance | 0% | 0% | 0% | 0% | 0% | 20% |
| (72 hr) | | | | | | |
| Corrosion | White Rust | White Rust | White Rust | White Rust | White Rust | White Rust |
| Resistance | 0% | 0% | 0% | 0% | 20% | 50% |
| After Erichsen | | | | | | |
| Test (48 hr) | | | | | | |
| Coefficient | 0.23 | 0.49 | 0.51 | 0.49 | 0.5 | 0.51 |
| of Friction | | | | | | |

TABLE 6

| | Comparative | | | | | | | |
|---|---|---|---|---|---|---|---|---|
| | Example 1 | Comparative | Comparative | Comparative | Comparative | Comparative | Comparative | Comparative |
| | (Cr Solution) | Example 2 | Example 3 | Example 4 | Example 5 | Example 6 | Example 7 | Example 8 |
| Solution | Good | Good | Good | Good | Good | Good | Good | Good |
| Stability | | | | | | | | |
| Corrosion | White Rust | White Rust | White Rust | White Rust | White Rust | White Rust | White Rust | White Rust |
| Resistance | 0% | 0% | 0% | 0% | 50% | 100% | 100% | 100% |
| (72 hr) | | | | | | | | |
| Corrosion | White Rust | White Rust | White Rust | White Rust | White Rust | White Rust | White Rust | White Rust |
| Resistance | 0% | 0% | 0% | 0% | 60% | 100% | 100% | 100% |
| After Erichsen | | | | | | | | |
| Test (48 hr) | | | | | | | | |
| Coefficient | 0.25 | 0.1386 | 0.13 | 0.12 | 0.098 | 0.088 | 0.09 | 0.09 |
| of Friction | | | | | | | | |

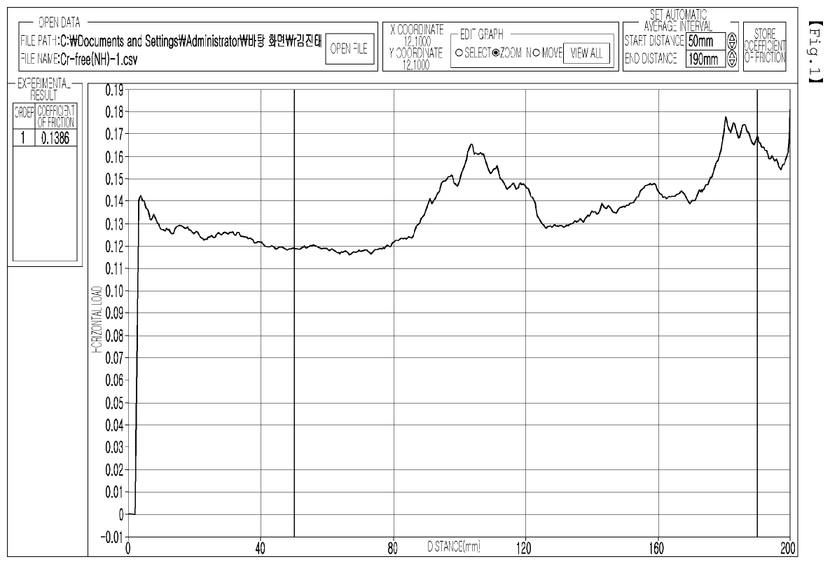

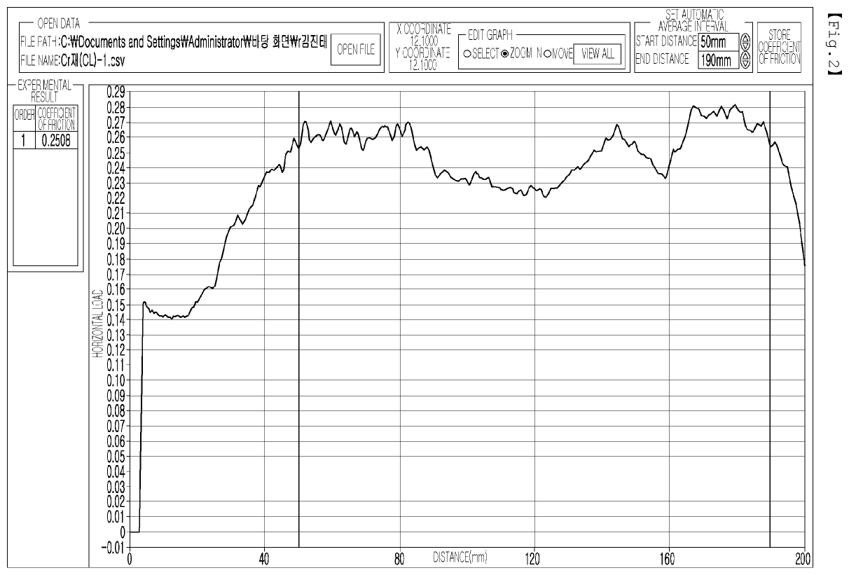

As indicated in Tables 4 to 6 and FIGS. 1 and 2, when the steel sheet was coated with the metal surface treatment composition, required properties such as corrosion resistance, and the like, was excellent, and a coefficient of friction was significantly increased.

While the example embodiments have been shown and described above, it will be apparent to those skilled in the art that modifications and variations could be made without departing from the scope of the present inventive concept as defined by the appended claims.

1. A chromium-free metal surface treatment composition, comprising:
10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent.

2. The chromium-free metal surface treatment composition of claim 1, wherein a wax is a polypropylene wax.

3. The chromium-free metal surface treatment composition of claim 1, wherein a weight average molecular weight of a wax is 2,000-10,000.

4. The chromium-free metal surface treatment composition of claim 1, wherein a melting point of a wax is 130-160° C.

5. The chromium-free metal surface treatment composition of claim 1, wherein an organic acid is one or more selected from among formic acid, phosphoric acid, and acetic acid.

6. The chromium-free metal surface treatment composition of claim 1, wherein a silane-based compound is one or more selected from a group consisting of epoxy-based silane and amino-based silane.

7. The chromium-free metal surface treatment composition of claim 6, wherein epoxy-based silane is one or more selected from among vinylmethoxy silane, vinyltrimethoxy silane, vinylepoxy silane, vinyltriepoxy silane, 3-aminopropyltriepoxy silane, 3-glycidoxy propyltrimethoxy silane, 3-methacryloxypropyltrimethoxy silane, 3-mercaptopropyl trimethoxy silane, N-(1,3-dimethylbutylidene)-3-(triepoxy silane)-1-propanamine, and N,N-bis[3-(trimethoxysilyl) propyl] ethylenediamine.

8. The chromium-free metal surface treatment composition of claim 6, wherein amino-based silane is one or more selected from among N-(β-aminoethyl)-γ-amino propylmethyldimethoxysilane, N-(β-aminoethyl)-γ-aminopropyltrimethoxysilane, γ-glycidoxypropyltriethoxysilane, γ-glycine cydoxitrimethyldimethoxysilane, 2-(3,4-epoxycyclohexyl)ethyltrimethoxysilane, γ-methacryloxypropyltrimethoxysilane, γ-methacryloxypropyltriethoxysilane, γ-mercaptopropyltrimethoxysilane, γ-mercapto propyltriethoxysilane, 3-amino propyl triethoxy silane, and N-[2-(vinylbenzylamino)ethyl]-3-aminopropyltrimethoxysilane.

9. The chromium-free metal surface treatment composition of claim 1, further comprising:
0.01-1 parts by weight of a defoamer and 1-2 parts by weight of a wetting agent.

10. The chromium-free metal surface treatment composition of claim 9, wherein a defoamer is n-methylethanol amine.

11. The chromium-free metal surface treatment composition of claim 9, wherein the wetting agent is one or more selected from among isopropyl alcohol, 2-ethyl-1-hexanol, 2-butoxyethanol, dipropylene glycol, ethylene glycol, n-propyl alcohol, and propylene glycol.

12. A chromium-free surface treatment metal material having excellent slip resistance, comprising:
a metal material; and
a coating layer formed on the metal material, and formed as a cured product of a metal surface treatment composition including 10-30 parts by weight of a silane-based compound, 0.5-6 parts by weight of an organic acid, 0.1-3 parts by weight of a vanadium compound, 0.1-3 parts by weight of a magnesium compound, 0.5-3 parts by weight of a wax and a balance of a solvent.

13. The chromium-free surface treatment metal material of claim 12, wherein a thickness of the coating layer is 0.5-10 μm.

14. The chromium-free surface treatment metal material of claim 12, wherein a coefficient of friction of the coating layer is 0.4-0.6.

15. The chromium-free surface treatment metal material of claim 12, wherein a wax is a polypropylene wax.

16. The chromium-free surface treatment metal material of claim 12, wherein a weight average molecular weight of a wax is 2,000-10,000.

17. The chromium-free surface treatment metal material of claim 12, wherein a melting point of a wax is 130-160° C.

18. The chromium-free surface treatment metal material of claim 12, wherein the metal surface treatment composition further includes 0.01-1 parts by weight of a defoamer and 1-2 parts by weight of a wetting agent.

19. The chromium-free surface treatment metal material of claim 12, wherein the metal material is one selected from among a stainless steel sheet, a galvanized steel sheet, an aluminum plated steel sheet, and an alloy plated steel sheet.
